(19) United States
(12) Patent Application Publication
(10) Pub. No.: US 2026/0324612 A1
(43) Pub. Date: Oct. 22, 2026

(54) Fishing Rod Jigging Device

(71) Applicant: Robert Shirk, Redmond, OR (US)

(72) Inventor: Robert Shirk, Redmond, OR (US)

(21) Appl. No.: 19/468,043

(22) Filed: Feb. 3, 2026

Related U.S. Application Data
(60) Provisional application No. 63/757,884, filed on Feb. 13, 2025.

(51) Int. Cl. A01K 91/06; A01K 97/10

(52) U.S. Cl. CPC A01K 91/065; A01K 97/10

(57) ABSTRACT

A fishing rod jigging device is provided. The device is configured to provide automated vertical and/or elliptical motion to a fishing rod to simulate the movement of live bait and enhance fish attraction in aquatic environments. The device comprises a receiving area adapted to retain fishing rods and an electric motor coupled to a linear actuation assembly configured to translate motor output into controlled vertical or oscillatory rod movements. A user interface is integrated to control oscillation parameters, motion profiles, and manual override functionality. In an alternative embodiment, the device incorporates a worm drive gearbox connected to a mechanical linkage selected from configurations such as a scotch yoke, crank-slider, or cam-follower mechanism to generate irregular bait movement.

### CROSS-REFERENCE TO RELATED APPLICATION

The present application claims priority to, and the benefit of, U.S. Provisional Application No. 63/757,884, which was filed on Feb. 13, 2025, and is incorporated herein by reference in its entirety.

### FIELD OF THE INVENTION

The present invention relates generally to the field of fishing. More specifically, the present invention relates to a fishing rod-attachable device configured to provide automated vertical and elliptical motion to a fishing rod using an electric motor and linear actuation assembly. Accordingly, the present disclosure makes specific reference thereto. Nonetheless, it is to be appreciated that aspects of the present invention are also equally applicable to other like applications, devices, and methods of manufacture.

### BACKGROUND

Fishing with multiple rods is a common practice among anglers seeking to improve their chances of catching fish, particularly during periods of low activity. In such scenarios, fishing rods are often placed in stationary holders either on boats or along shorelines, allowing anglers to wait passively for fish to bite. However, a significant limitation of this approach is the static nature of the bait presentation, which often fails to mimic the natural movement of live prey. Fish are more likely to strike at bait that appears to be active or injured, characteristics not typically achieved by motionless bait setups. While anglers can manually jig a rod to produce lifelike motion, doing so with multiple rods simultaneously is impractical. This restriction significantly reduces the effectiveness of using multiple rods and limits overall fishing efficiency. The challenge is further compounded in environments where manual rod manipulation is not feasible, such as cold weather, overnight fishing, or solo expeditions.

Therefore, there exists a long-felt need in the art for a fishing rod jigging device that simulates lifelike bait movement without requiring manual manipulation. There also exists a long-felt need in the art for a fishing rod jigging device that enables simultaneous operation of multiple rods to improve fish attraction. Moreover, there exists a long-felt need in the art for a fishing rod jigging device that provides adjustable and programmable motion settings to accommodate diverse fishing conditions.

The subject matter disclosed and claimed herein, in one embodiment thereof, comprises a fishing rod jigging device. The device is configured to provide automated vertical and/or elliptical motion to a fishing rod to simulate the movement of live bait and enhance fish attraction in aquatic environments. The device comprises a receiving area adapted to retain fishing rods of various sizes. The motion functionality of the device is provided by an electric motor coupled to a linear actuation assembly configured to translate motor output into controlled vertical or oscillatory rod movements. The device further comprises a tension-sensitive sensor configured to detect variations in rod movement indicative of a strike, which, upon detection, deactivates the motor and activates an alert system comprising an audible buzzer and LED indicator. A user interface is integrated to control oscillation parameters, motion profiles, and manual override functionality. In an alternative embodiment, the device incorporates a worm drive gearbox connected to a mechanical linkage selected from configurations such as a scotch yoke, crank-slider, or cam-follower mechanism to generate irregular bait movement. A programmable time delay relay enables mode selection such as “Aggressive,” “Natural Drift,” or “Pause-Strike,” and controls the operational timing of the oscillation cycle.

In this manner, the fishing rod jigging device of the present invention accomplishes all the foregoing objectives and provides a fishing rod-attachable device that simulates lifelike bait motion without requiring continuous manual effort, thereby increasing the probability of attracting fish. By enabling multiple rods to be operated simultaneously with independent motion profiles, the device addresses the limitation of anglers only being able to actively fish with one rod at a time. The integration of programmable controls, strike detection, and flexible mounting options ensures that the device adapts to a wide range of fishing environments and user preferences. The fishing rod jigging device thereby enhances the practicality and effectiveness of passive fishing strategies, making it a valuable tool for anglers seeking improved catch rates under diverse conditions.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fishing rod jigging device. The device is comprised of a fishing rod holder configured to simulate lifelike bait movement in aquatic environments, thereby enhancing the likelihood of attracting fish without requiring continuous manual operation by the angler.

The device is comprised of at least one receiving area configured to securely hold fishing rods of various sizes and geometries. In one embodiment, the receiving area is comprised of a contoured cradle with a concave profile and weather-resistant elastomeric padding that may be implemented as interchangeable inserts or overmolded surfaces. Additional embodiments of the receiving area may include spring-biased clamps, flexible retention straps with quick-release latches, dual clip mechanisms with high-friction clips, or segmented ratchet enclosures with adjustable sliding rails. Multiple receiving area types may be integrated into a single device for modular compatibility with various fishing equipment.

The device is further comprised of an electric motor configured to generate vertical oscillatory motion through a linear actuation assembly. The actuation assembly may include telescopic actuators, rack-and-pinion systems, or lead screw drives with anti-backlash features. The assembly is calibrated to replicate the vertical undulations of live bait.

The device is additionally comprised of a tension-sensitive sensor configured to detect changes in rod resistance or angular movement that indicate a fish strike. Upon detection, the sensor deactivates the motor and activates an alert system comprised of an audible buzzer and a high-visibility LED indicator. The buzzer operates within an adjustable decibel range, while the LED provides color-coded status alerts.

At least one control interface is provided to allow user adjustment of the motor's oscillation speed and stroke amplitude. A motion path selector enables toggling between different movement profiles, including linear and elliptical paths. A manual override button allows for temporary suspension of motion for bait repositioning or inspection.

In an alternative embodiment, the device is comprised of a worm drive gearbox configured for high torque and self-locking performance. The gearbox drives an oscillating shaft connected to a mechanical linkage that may include a scotch yoke, crank-slider, or cam-follower mechanism. These configurations produce varied motion dynamics that mimic the behavior of distressed bait.

This embodiment may also be comprised of a programmable time delay cycling relay controlled by microcontroller logic. The relay defines operational timing and is adjustable through at least one control to vary cycle durations. Preconfigured motion profiles include modes such as “Aggressive,” “Natural Drift,” and “Pause-Strike,” offering different bait simulation behaviors.

The device is further comprised of a power supply system configured for extended operation in outdoor settings. The power system includes at least one sealed battery providing power to all electrical components. A rechargeable configuration is supported through a charging port, which may be a USB-C or DC connector, and includes a sealing cap for protection. In another embodiment, a solar panel comprised of monocrystalline or polycrystalline cells supplies continuous trickle charging, with an optional charge controller to prevent battery overcharging.

At least one attachment point is included for secure mounting to various surfaces. The attachment point may be comprised of a ground stake, clip, or clamp, or an adjustable bracket with quick-release hardware. Rotational or tilt-adjustable features may be provided to allow precise alignment of the device with the fishing rod and the water surface. Multiple types of attachment points may be included or made interchangeable to support different fishing environments.

The invention is also comprised of a method of use wherein a user positions a fishing rod in the receiving area, configures motion parameters through the control interface, and initiates simulated bait movement via the electric motor and actuation assembly. The tension-sensitive sensor monitors for fish strikes and activates the alert system upon detection. A manual override function allows interruption of motion without disconnecting power.

In another method of use, the device is operated with a worm drive gearbox and mechanical linkage. The fishing rod is secured, and a motion mode is selected via control input. The gearbox and linkage produce various bait movement patterns based on the selected mode. The programmable cycling relay governs timing intervals, and the user may adjust settings to match fishing conditions.

Accordingly, the fishing rod jigging device of the present invention is particularly advantageous as it provides a fishing rod-attachable device that simulates lifelike bait motion without requiring continuous manual effort, thereby increasing the probability of attracting fish. By enabling multiple rods to be operated simultaneously with independent motion profiles, the device addresses the limitation of anglers only being able to actively fish with one rod at a time. The integration of programmable controls, strike detection, and flexible mounting options ensures that the device adapts to a wide range of fishing environments and user preferences. The fishing rod jigging device thereby enhances the practicality and effectiveness of passive fishing strategies, making it a valuable tool for anglers seeking improved catch rates under diverse conditions. In this manner, the fishing rod jigging device overcomes the limitations of existing fishing solutions known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a first potential embodiment of a fishing rod jigging device of the present invention in accordance with the disclosed architecture;

FIG. 2 illustrates a perspective view of a second potential embodiment of a fishing rod jigging device of the present invention in accordance with the disclosed architecture;

FIG. 3 illustrates a flowchart of a method of using a first potential embodiment of a fishing rod jigging device of the present invention in accordance with the disclosed architecture; and

FIG. 4 illustrates a flowchart of a method of using a second embodiment of a fishing rod jigging device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a fishing rod jigging device that simulates lifelike bait movement without requiring manual manipulation. There also exists a long-felt need in the art for a fishing rod jigging device that enables simultaneous operation of multiple rods to improve fish attraction. Moreover, there exists a long-felt need in the art for a fishing rod jigging device that provides adjustable and programmable motion settings to accommodate diverse fishing conditions.

The present invention, in one exemplary embodiment, is comprised of a fishing rod jigging device. The device is comprised of a fishing rod holder configured to replicate lifelike bait movement in aquatic environments, thereby improving the chances of attracting fish without requiring continuous manual effort by the angler.

The device is comprised of at least one receiving area configured to securely retain fishing rods of varying sizes and geometries. In one embodiment, the receiving area is comprised of a contoured cradle featuring a concave profile and weather-resistant elastomeric padding, which may be applied as interchangeable inserts or overmolded surfaces. Other embodiments may include spring-biased clamps, flexible retention straps with quick-release latches, dual clip mechanisms with high-friction engagement, or segmented ratchet enclosures with adjustable sliding rails. A combination of these receiving area types may be integrated into a single device to support modular use with diverse fishing gear.

The device is further comprised of an electric motor configured to produce vertical oscillatory movement through a linear actuation assembly. The actuation assembly may include telescopic actuators, rack-and-pinion configurations, or lead screw drives incorporating anti-backlash features. The assembly is calibrated to emulate the vertical motion patterns characteristic of live bait.

The device is additionally comprised of a tension-sensitive sensor configured to detect variations in rod resistance or angular displacement that indicate a potential fish strike. Upon detection, the sensor deactivates the motor and activates an alert system comprised of an audible buzzer and a high-visibility LED indicator. The buzzer operates within a user-adjustable decibel range, and the LED delivers color-coded visual signals.

At least one control interface is included to permit user-defined adjustments to the motor's oscillation speed and stroke amplitude. A motion path selector allows selection between various movement profiles, such as linear or elliptical paths. A manual override button permits temporary suspension of motion for bait repositioning or inspection purposes.

In an alternative embodiment, the device is comprised of a worm drive gearbox configured to deliver high torque output and self-locking capabilities. The gearbox powers an oscillating shaft connected to a mechanical linkage, which may be comprised of configurations such as a scotch yoke, crank-slider, or cam-follower mechanism. These configurations are designed to produce motion dynamics that simulate the erratic behavior of distressed bait.

This embodiment may also be comprised of a programmable time delay cycling relay governed by microcontroller-based logic. The relay defines motion intervals and is adjustable via at least one control to set custom cycle durations. Predefined motion profiles may include “Aggressive,” “Natural Drift,” and “Pause-Strike” to simulate various bait behaviors.

The device is further comprised of a power supply system configured for long-duration operation in outdoor environments. The power system includes at least one sealed battery that powers all functional components. A rechargeable configuration is supported through a charging port, which may be a USB-C or DC connector, and features a sealing cap for environmental protection. In an additional embodiment, a solar panel comprised of monocrystalline or polycrystalline cells supplies trickle charging to the battery, with an optional charge controller to prevent overcharging.

At least one attachment point is included to enable secure mounting to various surfaces. The attachment point may be comprised of a ground stake, a clip or clamp mechanism, or an adjustable bracket with quick-release hardware. Rotational or tilt-adjustable features may be included to optimize the orientation of the device relative to the rod and water surface. Multiple attachment point types may be incorporated or designed to be interchangeable for use in different fishing settings.

The invention is also comprised of a method of use in which a user secures a fishing rod in the receiving area, configures motion parameters using the control interface, and activates simulated bait motion via the electric motor and actuation assembly. The tension-sensitive sensor monitors for strike activity and activates the alert system upon detection. A manual override function allows for temporary halting of motion without disconnecting the power source.

In another method of use, the device is operated via a worm drive gearbox and mechanical linkage. The rod is secured, a motion mode is selected through user controls, and the gearbox and linkage generate movement based on the chosen profile. The programmable cycling relay governs motion intervals, and the user can adjust settings to align with specific fishing conditions.

As a result, the fishing rod jigging device offers a significant advantage by providing a rod-mounted solution that simulates lifelike bait motion without requiring continuous user engagement, thereby increasing the potential for fish attraction. The capability to operate multiple rods independently with distinct motion profiles addresses the limitation of manual single-rod operation. The inclusion of programmable controls, strike detection, and adaptable mounting configurations ensures compatibility with a broad range of fishing scenarios and user preferences. This fishing rod jigging device enhances the effectiveness of passive fishing techniques, offering anglers a practical and efficient tool to improve catch rates across varying conditions. The device thereby addresses and overcomes the limitations associated with conventional fishing solutions.

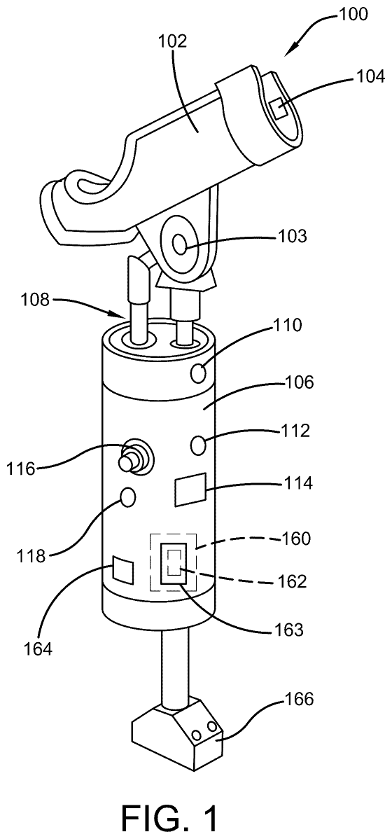

Referring initially to the drawings, FIG. 1 illustrates a perspective view of a first potential embodiment of a fishing rod jigging device 100 of the present invention in accordance with the disclosed architecture. The device 100 is comprised of a fishing rod holder configured to simulate lifelike bait movement in aquatic environments, thereby increasing the probability of attracting fish without requiring continuous manual input from the angler.

The device 100 is comprised of at least one receiving area 102 (as seen in FIG. 1) configured to securely retain fishing rods of various diameters, shapes, and handle geometries. In one embodiment, the receiving area 102 is comprised of a contoured cradle featuring a concave profile optimized for ergonomic rod seating. The receiving area 102 may be lined with weather-resistant padding 104 formed from durable elastomeric materials such as rubber or silicone, selected based on their high coefficient of friction and abrasion resistance. The padding 104 may be implemented in the form of interchangeable inserts or may be directly overmolded into the interior surfaces of the receiving area 102, enabling compatibility with a wide range of rod handle textures and materials.

In other embodiments, the receiving area 102 may include, but is not limited to, configurations such as a spring-biased clamp configured to apply a uniform gripping force to rod handles, a flexible retention strap secured by quick-release latches for accommodating non-standard handle profiles, a dual clip mechanism comprising opposing high-friction clips enabling rapid insertion and removal of the fishing rod, or a segmented ratchet enclosure adjustable via a sliding rail allowing for multi-position locking engagement. Multiple types of receiving areas 102 may be integrated into a single device 100, allowing for modularity and adaptation to diverse fishing equipment.

In one embodiment, the device 100 is further comprised of an electric motor 106 (as seen in FIG. 1) configured to generate vertical oscillatory motion through a linear actuation assembly 108. The receiving area 104 may attach to the motor 106 via at least one pivot point 103 such as, but not limited to, a hinge, a pivot pin, etc., that allows a user to change the angle of a fishing rod attached to the receiving area 102. The actuation assembly 108 may be in the form of a telescopic linear actuator, a rack-and-pinion arrangement driven by rotary-to-linear conversion, or a lead screw drive with anti-backlash nut configurations. The linear actuation assembly 108 may be calibrated to produce smooth, controlled up-and-down strokes replicating the vertical undulations of live bait species such as minnows, shad, or wounded fish.

The device 100 may be further comprised of a tension-sensitive sensor 110 (as seen in FIG. 1) configured to monitor variations in rod resistance or angular displacement indicative of a potential fish strike. Upon detecting such changes, the sensor 110 may immediately deactivate the motor 106 and activate an alert system 112. The alert system 112 may be comprised of an audible buzzer and a high-visibility LED indicator. The buzzer may emit sound within a user-adjustable decibel range, and the LED indicator may provide color-coded signaling, wherein a first color denotes an active strike event and a second color denotes standby or idle operation.

The device 100 may be further comprised of at least one control interface 114 enabling user-selectable adjustments to the oscillation speed and stroke amplitude of the motor 106 and/or actuation assembly 108. A motion path selector 116 may allow the user to toggle between different movement profiles, including linear vertical motion and elliptical or figure-eight trajectories, providing varied bait simulation styles. Additionally, a manual override button 118 enables temporary suspension of motion functionality without disengaging power to the system, allowing for bait repositioning or system inspection.

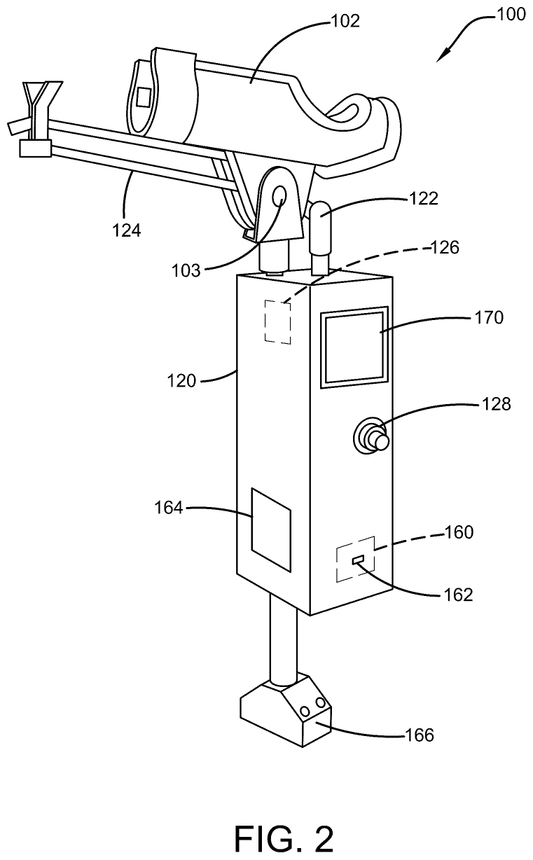

In an alternative embodiment, as seen in FIG. 2, the device 100 may incorporate a worm drive gearbox 120 engineered for high torque output and intrinsic self-locking properties. The gearbox 120 may drive an oscillating shaft 122 connected to a mechanical linkage 124. The linkage 124 may be comprised of configurations such as a scotch yoke mechanism offering direct reciprocating translation, a crank-slider mechanism providing elliptical oscillation, or a cam-follower assembly generating non-uniform stroke dynamics. These mechanical linkages may be optimized to generate fluid, erratic movements mimicking the natural twitch and sway of distressed bait.

This embodiment may be further comprised of a programmable time delay cycling relay 126 (as seen in FIG. 2) governed by microcontroller-based logic to control operational timing intervals. The cycling relay 126 may enable time-based sequences tailored to different fishing scenarios. At least one control 128 may be provided for adjustment of cycle durations, ranging from seconds to several minutes. User-selectable motion profiles may be included and preconfigured into the system, examples of which include an “Aggressive” mode featuring rapid, high-frequency movement, a “Natural Drift” mode providing slow, randomized undulations, and a “Pause-Strike” mode combining intermittent stillness with abrupt motion bursts to mimic prey vulnerability. The profiles can be displayed on an electronic display screen 170 and selected by the screen 170 (in a touchscreen embodiment) or by the control 128.

In one embodiment, the device 100 may be comprised of a power supply system configured to support extended autonomous operation in remote or outdoor environments. The power system may include at least one battery 160 housed within a sealed compartment to prevent moisture ingress. The battery 160 may be configured to supply electrical power to components such as the motor 106, actuation assembly 108, alert system 112, sensor 110, and control interfaces 114, 116, 118, and 128. To facilitate convenient energy replenishment, the device 100 may be rechargeable in one embodiment and is further comprised of a charging port 162, such as a USB-C or DC barrel connector, allowing for connection to external power sources, including portable chargers or vehicular adapters. The charging port 162 may be equipped with a protective cap or gasket 163 to ensure environmental sealing when not in use.

In an alternative embodiment, the device 100 may be comprised of a solar panel 164 configured to supply continuous trickle charging to the battery 160 under sunlight exposure, extending operational lifespan without the need for manual recharging. The solar panel 164 may be comprised of monocrystalline or polycrystalline photovoltaic cells selected based on efficiency and durability considerations. A solar charge controller may optionally be integrated to regulate voltage and prevent overcharging of the battery 160.

The device 100 is further comprised of at least one attachment point 166 (as seen in FIG. 1 and FIG. 2) configured to allow secure mounting of the device to a variety of surfaces, structures, or environmental features. The attachment point 166 may be implemented in various forms to accommodate different operational contexts. In one embodiment, the attachment point 166 may be comprised of a ground stake configured for insertion into soil, sand, or sediment, providing a stable anchor for shoreline or bank fishing scenarios. In another embodiment, the attachment point 166 may be comprised of a clip or clamp mechanism enabling temporary attachment to objects such as railings, boat edges, dock surfaces, or cooler handles. The attachment point 166 may also be comprised of a mounting bracket designed with adjustable fasteners or quick-release hardware, facilitating secure installation on flat or contoured surfaces. The attachment point 166 may further include rotational or tilt-adjustable features to allow precise orientation of the device 100 relative to the fishing rod and water surface. Multiple types of attachment points 166 may be provided or made interchangeable to ensure adaptability across diverse fishing environments and equipment configurations.

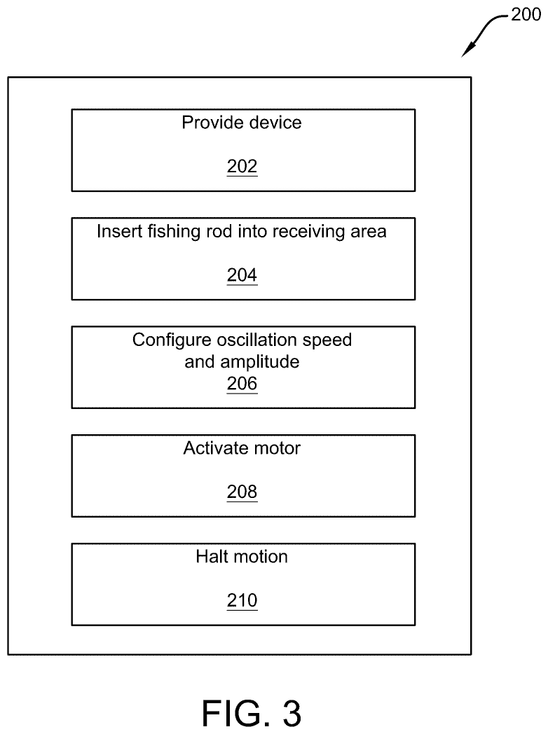

The present invention is also comprised of a method of using 200 the device 100, as seen in FIG. 3. First, a device 100 is provided comprised of a receiving area 102, weather-resistant padding 104, an electric motor 106, a linear actuation assembly 108, a tension-sensitive sensor 110, an alert system 112, at least one control interface 114, a motion path selector 116, and a manual override button 118 [Step 202]. Then, a fishing rod is inserted into the receiving area 102 such that the handle rests securely within the contoured cradle and engages the elastomeric padding 104 for frictional retention [Step 204]. Next, the user configures the oscillation speed and stroke amplitude of the electric motor 106 and the actuation assembly 108 via the control interface 114 and selects a desired motion profile using the motion path selector 116 [Step 206]. Then, the motor 106 is activated to initiate vertical or elliptical oscillatory motion of the fishing rod simulating lifelike bait activity [Step 208]. The tension-sensitive sensor 110 monitors resistance changes in the rod indicative of a fish strike and, upon detection, automatically deactivates the motor 106 and activates the alert system 112 to notify the user. Finally, the manual override button 118 may be used to temporarily halt motion without disconnecting power, allowing for bait inspection or repositioning [Step 210].

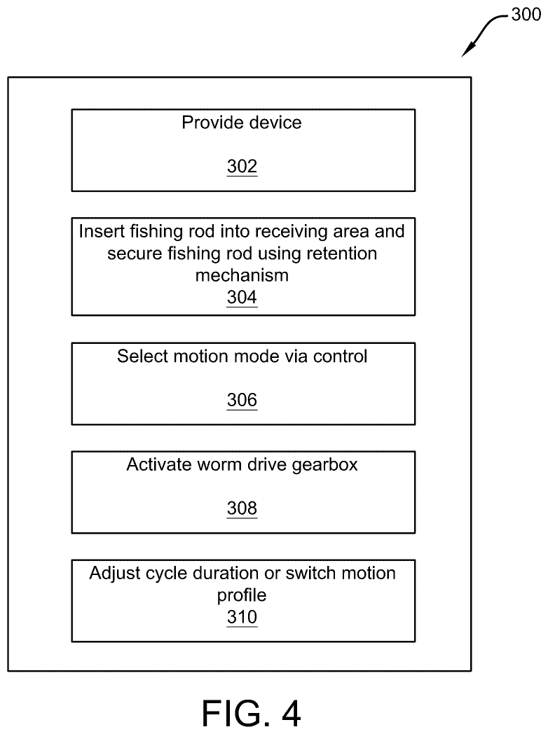

The present invention is also comprised of a method of using 300 the device 100, as seen in FIG. 4. First, a device 100 is provided comprised of a worm drive gearbox 120, an oscillating shaft 122, a mechanical linkage 124, a programmable time delay cycling relay 126, at least one control 128, and a receiving area 102 [Step 302]. Then, a fishing rod is positioned within the receiving area 102 and secured using a selected retention mechanism such as a spring-biased clamp, flexible strap, dual clip mechanism, or segmented ratchet enclosure based on the rod handle geometry [Step 304]. Next, the user selects a motion mode via the control 128, choosing from preconfigured profiles such as “Aggressive,” “Natural Drift,” or “Pause-Strike” [Step 306]. Then, the programmable cycling relay 126 activates the worm drive gearbox 120 to drive the oscillating shaft 122 and associated mechanical linkage 124, generating movement patterns such as elliptical, erratic, or non-uniform bait simulations [Step 308]. The device continues to operate in accordance with the programmed timing intervals defined by the relay 126, executing intermittent or continuous motion cycles based on the selected mode. Finally, the user may adjust cycle durations or switch between motion profiles via the control 128 to optimize bait presentation under varying fishing conditions [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fishing rod jigging device” and “device” are interchangeable and refer to the fishing rod jigging device 100 of the present invention.

Notwithstanding the foregoing, the fishing rod jigging device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the fishing rod jigging device 100 as shown in the FIGS. are for illustrative purposes only, and that many other sizes and shapes of the fishing rod jigging device 100 are well within the scope of the present disclosure. Although the dimensions of the fishing rod jigging device 100 are important design parameters for user convenience, the fishing rod jigging device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fishing rod jigging device comprising:
a receiving area;
a motion-generating mechanism operatively connected to the receiving area and configured to impart a motion to the receiving area, the motion-generating mechanism comprising a linear actuation assembly driven by an electric motor or a mechanical linkage driven by a worm drive gearbox;
a control system configured to adjust a parameters of the motion-generating mechanism; and
an attachment point.

2. The fishing rod jigging device of claim 1, wherein the receiving area is comprised of a cradle.

3. The fishing rod jigging device of claim 1, wherein the receiving area is comprised of a padding.

4. The fishing rod jigging device of claim 1, wherein the receiving area is comprised of a clamp, a strap, a clip, or a ratchet.

5. The fishing rod jigging device of claim 1 further comprised of a motion path selector.

6. The fishing rod jigging device of claim 1 further comprised of an alert system.

7. The fishing rod jigging device of claim 1, wherein the alert system is comprised of an audible buzzer.

8. The fishing rod jigging device of claim 1, wherein the alert system is comprised of an LED indicator.

9. The fishing rod jigging device of claim 1 further comprised of a control interface that allows a user to control an oscillation speed and a stroke amplitude of the motor or the actuation assembly.

10. The fishing rod jigging device of claim 1 further comprised of a battery.

11. The fishing rod jigging device of claim 10 further comprised of a solar panel that powers the battery.

12. A fishing rod jigging device comprising:
a receiving area;
an electric motor;
a linear actuation assembly operatively coupled to the electric motor and to the receiving area, the linear actuation assembly being configured to generate a vertical oscillatory motion;
a control system configured to adjust an oscillation speed and a stroke amplitude of the linear actuation assembly or the motor; and
an attachment point.

13. The fishing rod jigging device of claim 12, wherein the linear actuation assembly comprises a telescopic actuator, a rack-and-pinion arrangement, or a lead screw drive with an anti-backlash nut.

14. The fishing rod jigging device of claim 12, wherein the receiving area is comprised of a clamp, a strap, a clip, or a ratchet.

15. The fishing rod jigging device of claim 12 further comprised of a programmable time delay cycling relay.

16. The fishing rod jigging device of claim 12 further comprised of a battery.

17. A fishing rod jigging device comprising:
a receiving area;
a worm drive gearbox;
an oscillating shaft attached to and driven by the worm drive gearbox;
a mechanical linkage operatively coupled to the oscillating shaft and to the receiving area, the mechanical linkage being configured to generate a non-linear motion of the fishing rod;
a programmable time delay cycling relay configured to control operational timing intervals; and
an attachment point.

18. The fishing rod jigging device of claim 17, wherein the mechanical linkage comprises a scotch yoke mechanism, a crank-slider mechanism, or a cam-follower assembly.

19. The fishing rod jigging device of claim 17, wherein the receiving area is comprised of a clamp, a strap, a clip, or a ratchet.

20. The fishing rod jigging device of claim 17 further comprised of a battery.
